(19) United States
(12) Patent Application Publication
(10) Pub. No.: US 2023/0122153 A1
(43) Pub. Date: Apr. 20, 2023

(54) FIRE RETARDANT FIBER PREFORM AND FIRE RETARDANT VEHICLE COMPONENT

(71) Applicant: J. & P. COATS, LIMITED, Uxbridge (GB)

(72) Inventors: Probir Kumar Guha, Uxbridge (GB); George Han, Uxbridge (GB); Pradipkumar Bahukudumbi, Uxbridge (GB); John Ilkka, Uxbridge (GB)

(73) Assignee: J. & P. COATS, LIMITED, Uxbridge (GB)

(21) Appl. No.: 17/966,959

(22) Filed: Oct. 17, 2022

Related U.S. Application Data
(60) Provisional application No. 63/256,621, filed on Oct. 17, 2021.

(51) Int. Cl. B32B 5/06; B32B 5/12; B29C 70/22; B32B 5/26

(52) U.S. Cl. CPC B32B 5/073; B32B 5/12; B29C 70/22; B32B 5/26; B32B 2262/106; B29K 2307/04

(57) ABSTRACT

A fiber preform for use in an overmolding process is provide that includes a fiber bundle arranged in a predetermined pattern and attached to itself with thread stitches to form at least one preform layer. At least one intumescent material is associated with the at least one preform layer. A vehicle component having fire resistant characteristics is also provided that includes a housing having a first side and a second side. The housing has a shape that defines the vehicle component. An intumescent material is provided on at least one of the first side and the second side of the housing.

### RELATED APPLICATIONS

This application is a non-provisional application that claims priority benefit of U.S. Provisional Application Ser. No. 63/256,621 filed Oct. 17, 2021; the contents of which are hereby incorporated by reference.

### FIELD OF THE INVENTION

The present invention generally relates to a fiber preform for use in a resin transfer molding process, and more particularly to a fire retardant fiber preform for use in vehicle components that require fire resistance such as a battery box for containing battery cells of an electric vehicle.

### BACKGROUND

Tailored Fiber Placement (TFP) is a textile manufacturing technique in which fibrous material is arranged on another piece of base material and is fixed with an upper and lower stitching thread on the base material. The fiber material can be placed in curvilinear patterns of a multitude of shapes upon the base material. Layers of the fiber material may be built up to produce a two-dimensional fiber preform insert, which may be used as an insert overmolding or resin transfer process to create composite materials.

Resin transfer molding or overmolding (hereafter referred to synonymously as “RTM”) is a process in which the fiber preform in placed in a mold where a melt processible material is molded directly into the insert. Melt processible materials typically used in overmolding include elastomers and thermoplastics. The major overmolding processes includes insert molding and two-shot molding. Materials are usually chosen specifically to bond together, using the heat from the injection of the second material to form that bond that avoids the use of adhesives or assembly of the completed part, and results in a robust composite material part with a high-quality finish.

Composite materials are increasingly used in industry because of their high strength to weight ratios. Weight savings are particularly important for electric and hybrid vehicles powered with energy cells employing battery technologies in order to achieve greater vehicle driving range per charge. However, unique problems associated with some components of electric and hybrid vehicles have hindered the ability to use composite materials for some applications on hybrid or electric vehicles. For example, batteries of electric and hybrid vehicles present unique safety considerations owing to the high voltages of the batteries, chemicals employed in the battery technologies, combustion and fire risks associated with the batteries, and potential fume encounters if the batteries are broken or damaged.

Thus, there exists a need for a novel fiber preform having fire retardant characteristics for use in forming vehicle components that require fire resistance for safety purposes and for a fire resistant vehicle component.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 is a schematic view of a fiber bundle stitched to a substrate forming a fiber preform according to embodiments of the present invention;

FIG. 2 is a cross-sectional schematic view of a fiber bundle according to embodiments of the present invention;

FIG. 3 is an exploded perspective view a multi-layered fiber preform according to embodiments of the present invention;

FIG. 4 is a perspective view of the multi-layered fiber preform of FIG. 3;

FIG. 5 is s cross-sectional view of a fiber with an intumescent coating thereon;

FIGS. 6A-6D are a series of schematics of yarns operative in the present invention to generate a suitable char and include untwisted fiber yarn (FIG. 6A), twisted fiber yarn (FIG. 6B), high bulk fiber yarn (FIG. 6C), and stretch fiber yarn (FIG. 6D); and

FIG. 7 is a cross sectional view of a vehicle component according to embodiments of the present invention.

### SUMMARY OF THE INVENTION

A fiber preform for use in an overmolding process is provide that includes a fiber bundle arranged in a predetermined pattern and attached to itself with thread stitches to form at least one preform layer. At least one intumescent material is associated with the at least one preform layer.

A vehicle component having fire resistant characteristics is provided that includes a housing having a first side and a second side. The housing has a shape that defines the vehicle component. An intumescent material is provided on at least one of the first side and the second side of the housing.

### DETAILED DESCRIPTION OF THE INVENTION

The present invention has utility as a fiber preform having fire retardant characteristics for use in an overmolding process for forming vehicle components that require fire resistance for safety purposes, such as a battery box for containing battery cells of an electric vehicle. The present invention additionally has utility as a vehicle component having fire retardant characteristics and fire resistance for safety purposes, such as a battery box for containing battery cells of an electric vehicle.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Referring now to the figures, a fiber preform 10 according to embodiments of the present invention includes a fiber bundle 14 arranged in a predetermined pattern and attached to itself by a plurality of stitches 18 of a thread to form at least one preform layer 11. The inventive fiber preform 10 additionally includes at least one intumescent material 50 associated with the at least one preform layer 11. According to embodiments, the intumescent material 50 is applied to a plurality of fibers 15, 16 that make up the fiber bundle 14, to an exterior surface 13 of the fiber bundle 14, the thread 18, a substrate 12 of the fiber preform 10, a surface of the at least one preform layer 11, or a combination thereof.

The fiber bundle 14 is arranged in a predetermined pattern by a selective comingled fiber bundle positioning (SCFBP) method and attached to itself, and/or according to embodiments a substrate 12, by a plurality of stitches 18 of a thread, which according to some embodiments is a thermoplastic thread formed of a nylon or polyethylene material. According to embodiments that include a substrate 12, the substrate 12 acts as a foundation or base upon with a fiber bundle 14 is applied. The substrate 12 may be a tear-off fabric or paper, a thermoset or thermoplastic sheet, or other suitable material. According to embodiments, the substrate 12 is used as a foundation upon which the fiber bundle 14 is applied in the predetermined pattern but is torn off prior to placement of the fiber preform 10 in a mold.

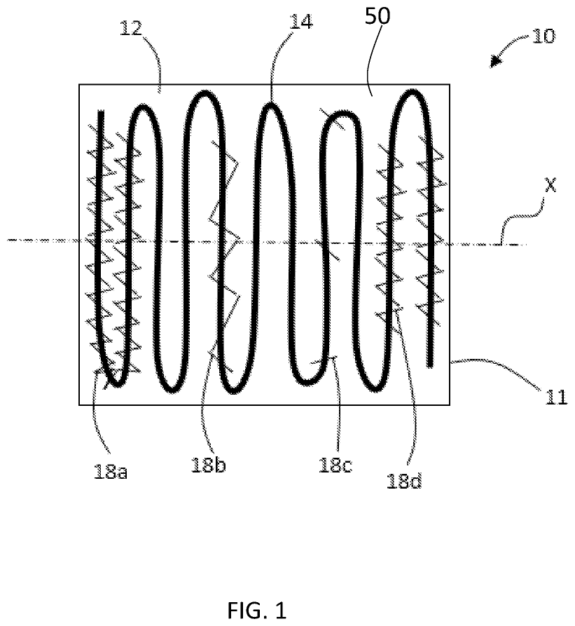

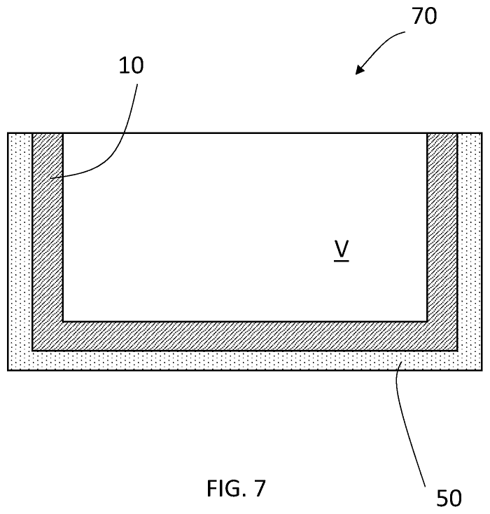

The predetermined pattern in which the fiber bundle 14 is arranged may generally resemble the shape of the designed final composite material component, for example a vehicle component 70 of an automobile, such as a battery containment construct for housing energy cells of an electric vehicle, such as that shown in cross section in FIG. 7. The fiber bundle 14 may be arranged in a principal direction, i.e. a principal direction of stress of the final composite material component. In FIG. 1, the principal orientation of the fiber bundle 14 is along a longitudinal axis X of the fiber preform 10, however, other suitable orientations are also possible and may be used based on the design considerations and stresses for each composite material part. FIG. 1 illustrates only a first preform layer 11.

The fiber bundle 14 is attached to itself and/or to a substrate 12 by a plurality of stitches 18 of thread. In some embodiments, the thread is a thermoplastic thread, such as nylon or polyethylene. As shown in FIG. 1, the plurality of stitches 18 are shown in various zig-zag stitch arrangements. For example, the stitches may be closely spaced stitches 18a and 18d or spaced apart by a greater linear distance such as stitches 18b and 18c. The stitches may be continuously connected along the fiber bundle 14 such as stitches 18a, or the stitches may be discrete and separate single stitches 18c or separate groups of stitches such as stitches 18b and 18d.

The at least one intumescent material 50 associated with the at least one preform layer 11 provides fire resistance to the fiber preform 10 and ultimately the vehicle component 70 formed using the fiber preform 10, which is particularly useful for vehicle components that are subject to strict fire safety regulations such as components near or surrounding vehicle batteries. An intumescent material is one that undergoes a chemical change when exposed to heat or flames, becoming viscous, forming expanding bubbles that harden into a dense, heat insulating multi-cellular char. The objectives of intumescent technology are the containment of fire and toxic gases by inhibiting flame penetration, heat transfer and transport of toxic gases from the site of a fire to other parts of a structure. According to embodiments, an intumescent material 50 is provided on such vehicle components and when exposed to extreme heat or fire expands and chars to seal the vehicle component to resist fire penetration and prevent the spread of fumes. An intumescent is a substance that swells as a result of heat exposure, thus increasing in volume and decreasing in density. The term intumescent when applied to fire protective coatings refers to a technology wherein the coating will swell and form multi-layered char foam when exposed to heat. High carbon containing chars are extremely heat resistant and can be employed in critical high temperature applications such as the carbon on carbon composites that are machined to produce rocket exhaust nozzles. The production of these carbon on carbon composites involves the combination of graphite fibers with high char yield epoxies. After curing, these parts are graphitized in a high-pressure autoclave at high temperatures. Intumescent materials can be thermally stable to above 1,000° C. (1,832° F.). With the right choice of materials, intumescent coatings can produce a low thermally conductive char foam. Thus, a coating that includes an intumescent substance can form a char foam that has a low thermal conductivity when exposure to fire and/or extreme heat.

Soft char intumescent substances can produce a light char that is a poor conductor of heat, thus retarding heat transfer. Typically, these intumescent substances can also contain a significant amount of hydrates. As the hydrates are spent, water vapor is released, which has a cooling effect. Once the water is spent, the insulation characteristics of the char that remains can slow down heat transfer from the exposed side to the unexposed side of vehicle component 70 that includes an intumescent coating or sheet 50. Typically, the expansion pressure that is created for these products is very low, because the soft carbonaceous char has little substance, which is beneficial if the aim is to produce a layer of insulation. Harder char intumescent substances can be produced with sodium silicates and graphite. These intumescent substances can produce a more substantial char capable of exerting quantifiable expansion pressure.

Commercial examples of an intumescent substance that are available include INTUMAX manufactured by Broadview Technologies, Inc. located in Newark, N.J. Such intumescent agents can allow the use of less intumescent agent in a binder's formulation, which, in turn, can improve the physical and adhesive properties of the coatings. Many others sources of intumescent substances that can be added to binder materials are available.

Intumescent substances can be added to binder materials such as, but not limited to, acrylic resins, styrene-butadiene rubber (SBR), polyvinyl alcohol, ethyl vinyl acetate resins, phenolic resins, etc., and combinations thereof. These binder materials can be modified as desired to crosslink (e.g., with a crosslinking agent, such as melamine formaldehyde) or to change other characteristics such as hydrophobicity, hydrophilicity, viscosity, pH, etc. As such, other materials and components can be included within the intumescent coating. For example, waxes, plasticizers, rheology modifiers, antioxidants, antistats, antiblocking agents, and other additives may be included as desired. Surfactants may be added to help disperse some of the ingredients, especially the film-forming binder within the solvent system. When present, a surfactant(s) can be included in the heat resistant coating up to about 20%, such as from about 0.5% to about 5%. Exemplary surfactants can include nonionic surfactants and/or ionic surfactants.

A plasticizer may also be included in the intumescent coating. A plasticizer is an additive that generally increases the flexibility of the final coating by lowering the glass transition temperature for the binder (and thus making it softer). In one embodiment, the plasticizer can be present in the heat resistant coating 104 up to about 25%, such as from about 5% to about 20%, by weight. Likewise, viscosity modifiers can be present in the heat resistant coating. Viscosity modifiers are useful to control the rheology of the coatings in their application. A particularly suitable viscosity modifier is high molecular weight poly(ethylene oxide). The viscosity modifier can be included in any amount to help the coating process, such as up to about 5% by weight, such as about 0.5% to about 3% by weight.

According to embodiments, the intumescent material 50 is formed from thermoplastic fiber proximal to cellulosic fiber in various relative configurations provided within the fiber bundle 14. Such thermoplastic fibers operative herein illustratively include disparpolypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. Cellulosic fibers, synonymously referred to herein as cellulosics, operative herein include cotton, linen, rayon, bamboo, hemp, sisal, jute, and celluolose ether reaction products of any of the aforementioned. As used herein cellulose ethers include methylcellulose (MC), hydroxypropylmethylcellulose (HPMC), hydroxyethylcellulose (HEC) and carboxymethylcellulose (CMC). Suitable cellulosic fibers, include, but are not limited to, natural and synthetic cellulosic fibers (e.g., cotton, rayon, acetate, triacetate, and lyocell, as well as their flame resistant counterparts FR cotton, FR rayon, FR acetate, FR triacetate, and FR lyocell). Examples of rayon fibers include Viscose™ and Modal™ by Lenzing, available from Lenzing Fibers Corporation. An example of an FR rayon material is Lenzing FR™, also available from Lenzing Fibers Corporation, and VISIL™, available from Sateri. Examples of lyocell fibers include TENCEL™, TENCEL G100™ and TENCEL A100™, all available from Lenzing Fibers Corporation. Examples of vinal fibers include Kuralon™ fibers available from Kuraray. The synthesis of cellulose ethers from cellulose is known to the art as detailed in P. Nasatto et al., “Methylcellulose, a Cellulose Derivative with Original Physical Properties and Extended Applications” Polymers 2015, 7, 777-803.

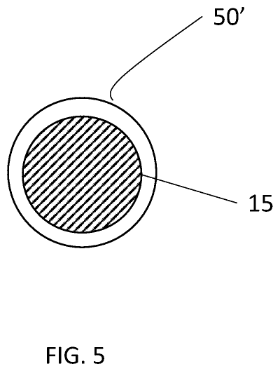

In still other embodiments, a coating of an intumescent material, such as that described above, referred to herein synonymously as a sizing, is applied to any fiber present in a fiber bundle. Coating materials operative herein illustratively include poly(vinylphosphonic acid); a mixture of ammonium polyphosphate, pentaerythritol and melamine; double-hydroxide modified phosphate esters in resin matrices; and combinations thereof. Thermoplastic sizing based on poly(vinylphosphonic acid) are detailed in B K Kandola et al. Molecules 2020, 25, 688-703. A cross-sectional view of a fiber 15 with an intumescent coating 50′ applied thereon is shown in FIG. 5.

According to embodiments, a char layer is generated that is protective of the thermoplastic fibers within the fiber bundle 14. Without intending to be bound to a particular mechanism, it is believed that the cellulosic fiber material combusts with kinetic rapidity relative to the thermoplastic fiber content to generate a char residue that deposits on proximal thermoplastic within the fiber bundle 14. The alteration of the surface energy of the fiber bundle 14 with a fluorocarbon finish, results in fire resistivity being provided to the fiber bundle 14.

Proximity of thermoplastic fiber to cellulosic fiber is achieved by direct contact between adjacent fibers, or such fibers are separated by a distance of 1 to 3 fiber diameters therebetween. Fibers are in intimate contact given the length of the fibers and the blending process, some portion of cellulosic fibers will always make contact with the thermoplastic fibers. This proximity is achieved through conventional textile manufacture techniques using a yarn that include both thermoplastic fiber and cellulosic fiber content.

Typical fiber diameters according to such embodiments of the present invention are independent for each of the thermoplastic fiber and cellulosic fiber. It is appreciated that a variety of fiber diameters are readily spun together to form a yarn. Textile fibers are reported in denier (indirect measure of diameter). The denier of fibers used for both cellulosic and thermoplastic is roughly 1.5 denier. In inventive embodiments, the average fiber (based on number average) diameter ratio of the thermoplastic fiber:cellulosic fiber is 1:1, however the ratio may range from 0.8:1 to 1.2:1.

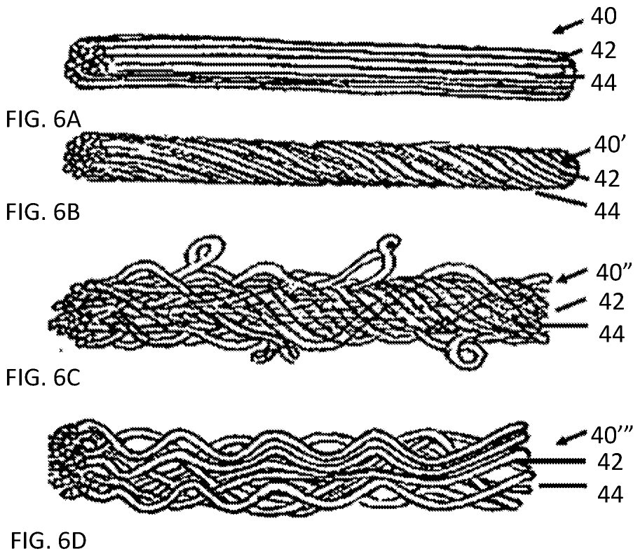

FIGS. 6A-6D show yarn constructs operative in the present invention at 40, 40′, 40″ and 40′″, respectively that according to embodiments, are included in the fiber bundle 14. Each yarn includes thermoplastic fiber 42 and cellulosic fiber 44. The volume ratio of cellulosic:thermoplastic:content varies between 3:1 (75% cellulosic fiber and 25% thermoplastic fiber), and in some inventive embodiments from 1:1-3:1 (50-75% cellulosic and 25-50% thermoplastic) in a yarn 40, 40′, 40″ or 40′″. The yarns take the form of untwisted fiber yarn 40 (FIG. 6A), twisted fiber yarn 40′ (FIG. 6B), high bulk fiber yarn 40″ (FIG. 6C), and stretch fiber yarn 40″′ (FIG. 6D). In specific inventive embodiments, both cellulosic and thermoplastic fibers were 1.5 denier in size (size ratio of 1:1).

According to further embodiments, the intumescent material 50 is an intumescent graphite, which is an expandable graphite. Such intumescent graphite is advantageous in that it is biologically inert, non-toxic, free of heavy metals, halogen free, and insoluble in water and other solvents. According to embodiments, the expandable graphite has a start expansion temperature (SET) between 150 and 300° C., which may be tuned based on the processing conditions to be used with a given fiber preform 10 and its processing to a completed vehicle component. According to embodiments, the expandable graphite is provided as a coating, a putty, a strip, a foam, or a combination thereof. Expandable graphite is advantageous in that it expands under heat, fire, and/or pressure exposure. Additionally, expandable graphite is advantageous in that it has a neutral pH value, low initial viscosity, high SET, and small particle size. According to embodiments, the expandable graphite intumescent material 50 is applied to a plurality of fibers 15,16, 42, 44 that make up the fiber bundle 14, to an exterior surface 13 of the fiber bundle 14, the thread 18, a substrate 12 of the fiber preform 10, a surface of the at least one preform layer 11, or a combination thereof.

According to embodiments, the substrate 12 is formed of an intumescent sheet 50 or such an intumescent sheet is applied to a side of the preform 10 or to an already formed vehicle component 70, as shown in FIG. 7. According to embodiments, such an intumescent sheet 50 is formed with a thin coating (ca. 0.25-0.5 mm thick) of poly(vinylphosphonic acid) (PVPA) crosslinked with triallylisocyanurate (TAIC) or an intumescent coating described above applied to the surfaces of a thermoset resin, such as glass-fiber reinforced epoxy resin composites, or a simple thermoplastic, such as poly(methyl methacrylate) sheet.

FIG. 1 illustrates only a first preform layer 11. According to some embodiments, the fiber preform 10 includes at least one preform layer 11. According to some embodiments of the present invention, the fiber preform includes a plurality of subsequent preform layers formed of the fiber bundle 14 successively stacked from the first preform layer 11. Each subsequent preform layer is arranged on a preceding preform layer and is attached to the preceding preform layer by additional stitches of the thread 18. The fiber bundle 14 that forms each of the subsequent preform layers may be a continuation of the fiber bundle of the preceding preform layer or it could be a separate piece of fiber bundle 14.

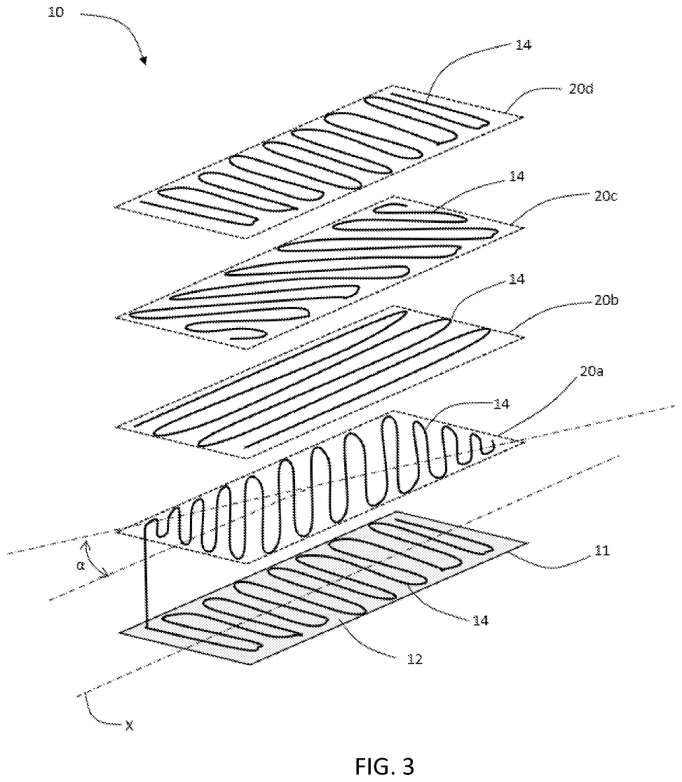

Referring now to FIG. 3, the fiber preform 10 according to one embodiment of the present invention includes the first preform layer 11 with its principal orientation along the X axis and a plurality of subsequent preform layers 20a, 20b, 20c, 20d formed of the fiber bundle 14 successively stacked from the first preform layer 11. Each subsequent preform layer 20a, 20b, 20c, 20d is arranged on a preceding preform layer and attached to the preceding preform layer by additional stitches of the thread 18. For example, the first subsequent preform layer 20a is arranged on and attached to the preceding first preform layer 11, the second subsequent preform layer 20b is arranged on and attached to the preceding first subsequent preform layer 20a, the third subsequent preform layer 20c is arranged on and attached to the preceding second subsequent preform layer 20b, and the fourth subsequent preform layer 20d is arranged on and attached to the third subsequent preform layer 20c. While the example fiber preform 10 shown in FIG. 3 includes four subsequent preform layers for a total of five preform layers including the first preform layer, it is appreciated that the plurality of subsequent preform layers may include two to twenty layers. The fiber bundle 14 that forms each of the subsequent preform layers may be a continuation of the fiber bundle of the preceding preform layer or it could be a separate piece of fiber bundle.

In FIG. 3, the plurality of stitches of thread 18 are not shown for the sake of clarity, but it will be readily understood that each layer of fiber bundle 14 is attached to the preceding layer and/or to itself by a plurality of stitches identical to those explained throughout the present disclosure. It is appreciated that the stitches used to secure each subsequent preform layer could extend to the substrate. Alternatively, the stitches used to attach each subsequent preform layer can extend to the preceding preform layer, which allows for a more efficient preform manufacturing process in that the penetration depth of the stitching needle need not be altered between the various layers of fiber bundle. After at least one of the subsequent preform layers has been stacked and attached to the first preform layer, the substrate 12 may be removed from the fiber preform. Alternatively, the substrate 12 may remain attached to the first preform layer 11 until all of the subsequent preform layers have been stacked on and attached to the preceding preform layer, or the substrate 12 can remain attached to the fiber preform 10 throughout the composite material manufacturing process, particularly when the substrate includes an intumescent coating or is formed of an intumescent material.

As shown in FIG. 3, the orientation of each subsequent preform layer may be offset from the orientation of the preceding preform layer. Offsetting the orientation of the various layers enables strength in multiple directions. The orientation of each subsequent preform layer may be offset from that of the preceding preform layer by an angular displacement a relative to the principal orientation of the first layer, for example the X axis. The layers can be overlaid with a variety of angular displacements relative to a first layer. If zero degrees is defined as the long axis X of the first preform layer 11, the subsequent preform layers are overlaid at angles of 0-90°. For example, in the fiber preform 10 shown in FIG. 3, the angular displacement α is 45° resulting in a 0-45-90-45-0 pattern of preform layers. Further specific patterns illustratively include 0-45-90-45-0, 0-45-60-60-45-0, 0-0-45-60-45-0-0, 0-15-30-45-60-45-30-15-0, and 0-90-45-45-60-60-45-45-90-0. While these exemplary patterns are for from 5 to 10 layers of uni-directional fibers, it is appreciated that the fiber preform may include from 3 to 20 layers. It is appreciated that the preform layers may be symmetrical about a central layer, in the case of an odd number of layers, or about a central latitudinal plane parallel to the players. That is, as shown in FIG. 3, the orientation of the first layer 11 and the last of the subsequent preform layers 20d are generally the same while the first subsequent layer 20a and third subsequent preform layer 20c are symmetrical with one another, such that the layers 11, 20a, 20c, and 20d are symmetrical about the center layer 20b. Providing the various preform layers with symmetrical orientations enables the fiber preform 10 to resist warping. In addition to the substantially linear pattern of comingled fiber bundle positioning depicted in drawings with interspersed swithchbacks, it is appreciated that other patterns operative herein illustratively include spirals, and any space filling curve such as a Peano curve, dragon curve, or Sierpinksi curve.

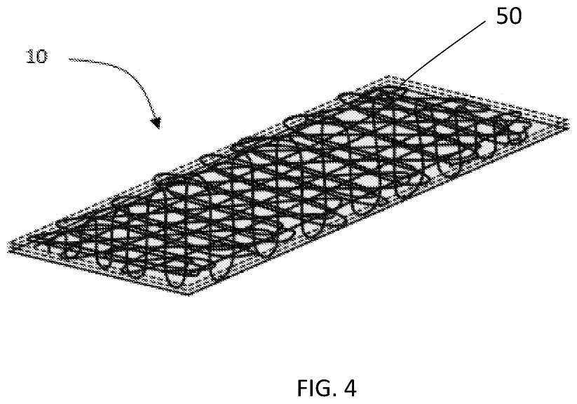

As shown in FIG. 4, the fiber preform 10 having of a plurality of preform layers has a generally two-dimensional shape, that is, while the various layers give the fiber preform 10 a thickness, the fiber preform is substantially flat or planar. Often, it is desired that the composite materials formed using a fiber preform of the present disclosure have a three-dimensional shape, for example a curve, an angle, or some other non-planar configuration. To manufacture three-dimensional composite material parts, a fiber preform is placed in a mold having a three-dimensional shape corresponding to the shape of the desired final composite material part, such as a battery containment component. For example, as show in FIG. 7, a vehicle component 70 has a three-dimensional shape forming a battery box, shown in cross section. As shown, the previously generally planar preform 10 has been molded to have a three-dimensional shape that defines a volume V that is configured to receive and retain contents such as at least one battery. Such a battery box may additionally include a lid, which may be formed of the same material as the box. As shown in FIG. 7, the vehicle component 70 includes an intumescent material 50, as described above, positioned on an outer surface of the vehicle component 70. It is also appreciates that the intumescent material 50 may additionally or alternatively be positioned on an interior surface of the vehicle component 70.

According to embodiments, the fiber bundle 14 is made of reinforcing fibers, such as those made of 100% carbon, 100% glass, or 100% aramid fibers, or a combination thereof. According to certain embodiments, the fiber bundle 14 includes matrix fibers, being of a thermofusible nature may be formed from a thermoplastic material such as, for example, polypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. The thermoplastic fibers are appreciated to be recycled, virgin, or a blend thereof. The thermofusible thermoplastic matrix fibers have a first melting temperature at which point the solid thermoplastic material melts to a liquid state. The reinforcing fibers may also be of a material that is thermofusible provided their thermofusion occurs at a temperature which is higher than the first melting temperature of the matrix fibers so that, when both fibers are used to create a composite, at the first melting temperature at which thermofusibility of the matrix fibers occurs, the state of the reinforcing fibers is unaffected. As used herein, any reference to weight percent or by extension molecular weight of a polymer is based on weight average molecular weight. As used herein, the term melting as used with respect to thermoplastic fibers or thread is intended to encompass both thermofusion of fibers such that a vestigial core structure of separate fibers is retained, as well as a complete melting of the fibers to obtain a homogenous thermoplastic matrix. The thermoplastic fibers are appreciated to be recycled, virgin, or a blend thereof. The thermoplastic fibers in a comingled fiber bundle constitute from 20 to 80 weight percent of the comingled fibers in the present invention.

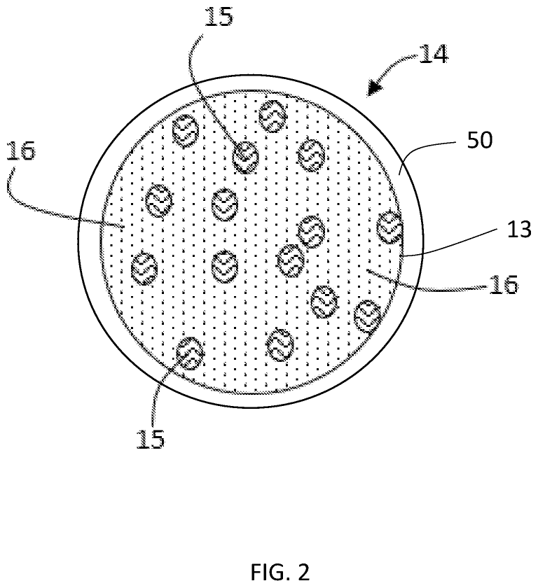

As shown in FIG. 2, the fiber bundle 14 may include a subset of comingled fiber bundle fibers 15, a subset of roving fibers 16, or a combination thereof. The comingled fiber bundle fibers 15 are helical or spun while the roving fibers are parallel to one another and not helical. The fiber bundle 14 may be a single continuous fiber bundle fed from a spool in the SCFBP process to form the fiber preform 10. Alternatively, the fiber preform 10 may be formed of multiple separate fiber bundles. Using multiple fiber bundles to form the fiber preform allows for fiber bundles having different thermoplastic fibers and reinforcing fibers, which enables tuning of the fiber preform insert. Additionally, increasing the number of fiber bundles used in the SCFBP process speeds the fiber preform manufacturing process, which increases throughput and efficiency. The multiple fiber bundles may be applied to the substrate together starting from the same end of the substrate or they may be applied spaced apart with each beginning at opposite ends of the substrate and converging at a middle region between the ends of the substrate.

The fiber preform 10 is tunable and easily changed and adapted for varying design requirements. The properties and characteristics of the fiber preform may be changed and modified based on controlling parameters of the various components of the fiber preform including parameters of the fiber bundle 14, the thread, and the plurality of stitches 18. Parameters of the fiber bundle may include, but are not limited to, a diameter of the fiber bundle, a ratio of the thermoplastic fibers to the reinforcing fibers, a composition of the thermoplastic fibers, and a composition of the reinforcing fibers. Parameters of the thread may include, but are not limited to, a denier of the thread, a composition of the thread, and a melting temperature of the thread. The parameters of the plurality of stitches 18 may include, but are not limited to, a linear distance between the stitches and a tension of the stitches.

The foregoing description is illustrative of particular embodiments of the invention, but is not meant to be a limitation upon the practice thereof. The following claims, including all equivalents thereof, are intended to define the scope of the invention.

1. A fiber preform for use in an overmolding process, the fiber preform comprising:
a fiber bundle arranged in a predetermined pattern and attached to itself by a plurality of stitches of a thread to form at least one preform layer; and
at least one intumescent material associated with the at least one preform layer.

2. The fiber preform of claim 1 wherein the fiber bundle comprises carbon fibers, glass fibers, aramid fibers, or a combination thereof.

3. The fiber preform of claim 1 wherein the fiber bundle includes a subset of yarn fibers, a subset of roving fibers, or a combination thereof.

4. The fiber preform of claim 1 wherein the intumescent material is applied to a plurality of fibers that make up the fiber bundle.

5. The fiber preform of claim 1 wherein the intumescent material is applied to an exterior surface of the fiber bundle.

6. The fiber preform of claim 1 wherein the thread is a thermoplastic thread.

7. The fiber preform of claim 1 wherein the intumescent material is applied to the thread.

8. The fiber preform of claim 1 further comprising a substrate to which the fiber bundle is attached by the plurality of stitches of the thread.

9. The fiber preform of claim 8 wherein the intumescent material is applied to the substrate.

10. The fiber preform of claim 1 wherein the intumescent material is applied to a surface of at least one preform layer or to a surface of at least one fiber of the at least one preform layer.

11. The fiber preform of claim 1 further comprising a plurality of subsequent preform layers formed of the fiber bundle and successively stacked from the first preform layer, each subsequent preform layer arranged on a preceding preform layer and attached to the preceding preform layer by additional stitches of the thread, wherein each subsequent preform layer includes a portion of the intumescent material.

12. The fiber preform of claim 1 wherein the intumescent material is expandable graphite.

13. The fiber preform of claim 1 wherein the intumescent material has a start expansion temperature (SET) between 150 and 300° C.

14. A vehicle component having fire resistant characteristics, the vehicle component comprising:
a housing having a first side and a second side, the housing having a shape that defines the vehicle component; and
a first intumescent material provided on at least one of the first side and the second side of the housing.

15. The vehicle component of claim 14 wherein the housing is formed of an overmolded fiber preform.

16. The vehicle component of claim 15 wherein the fiber preform is formed of a fiber bundle arranged in a predetermined pattern and attached to itself by a plurality of stitches of a thread to form at least one preform layer.

17. The vehicle component of claim 14 wherein a second intumescent material is applied to a plurality of fibers that make up the fiber bundle, an exterior surface of the fiber bundle. to the thread, or a combination thereof.

18. The vehicle component of claim 14 wherein the first intumescent material is an intumescent sheet.

19. The vehicle component of claim 14 wherein the first intumescent material is expandable graphite.

20. The vehicle component of claim 14 wherein the first intumescent material has a start expansion temperature (SET) between 150 and 300° C.
